(19) United States
(12) Patent Application Publication
(10) Pub. No.: US 2024/0378433 A1
(43) Pub. Date: Nov. 14, 2024

(54) Neural Network Quantization Based on a Power Function

(71) Applicant: Datakalab, Paris (FR)

(72) Inventors: Edouard Yvinec, Paris (FR); Arnaud Dapogny, Paris (FR); Kevin Bailly, Ivry sur Seine (FR); Lucas Fischer, Neuilly sur Seine (FR)

(73) Assignee: Datakalab, Paris (FR)

(21) Appl. No.: 18/142,652

(22) Filed: May 3, 2023

(51) Int. Cl. G06N 3/08

(52) U.S. Cl. CPC G06N 3/08

(57) ABSTRACT

The disclosure notably relates to a computer-implemented method for neural network quantization. The method comprises obtaining a neural network. The method further comprises obtaining a quantization operator. The quantization operator is based on a power function. The power function has a power exponent. The method further comprises quantizing the neural network based on the quantization operator. The quantization includes searching for an optimal value of the power exponent based on a quantization error associated with the quantization operator.

### TECHNICAL FIELD

The disclosure relates to the field of computer programs and systems, and more specifically to a method, system and program for neural network quantization.

### BACKGROUND

Deep neural networks (DNNs) tremendously improved algorithmic solutions for a wide range of tasks. In particular, in computer vision, these achievements come at a consequent price, as DNNs deployment bares a great energetic price. Consequently, the generalization of their usage hinges on the development of compression strategies. Quantization is one of the most promising such technique, that consists in reducing the number of bits needed to encode the DNN weights and/or activations, thus limiting the cost of data processing on a computing device.

Existing DNN quantization techniques, for computer vision tasks, are numerous and can be distinguished by their constraints. One such constraint is data usage, and is based upon the importance of data privacy and security concerns. Data-free approaches exploit heuristics and weight properties in order to perform the most efficient weight quantization without having access to the training data. As compared to data-driven methods, the aforementioned techniques are more convenient to use but usually come with higher accuracy loss at equivalent compression rates. Data-driven methods performance offer an upper bound on what can be expected from data-free approaches.

For simplicity reasons, most quantization techniques perform uniform quantization, i.e. they consist in mapping floating point values to an evenly spread, discrete space. However, non-uniform quantization can theoretically provide a closer fit to the network weight distributions, thus better preserving the network accuracy. Existing work on non-uniform quantization either focused on the search of binary codes or leverage logarithmic distribution. However, these approaches map floating point multiplications operations to other operations that are hard to leverage on current hardware (e.g. bit-shift) as opposed to uniform quantization which maps floating point multiplications to integer multiplications.

Motivated by the growing concerns for privacy and security, data-free quantization methods are emerging and have significantly improved over the recent years. The first breakthrough in data-free quantization was based on two mathematical ingenuities. First, they exploited the mathematical properties of piece-wise affine activation functions (such as e.g. ReLU based DNNs) in order to balance the per-channel weight distributions by iteratively applying scaling factors to consecutive layers. Second, they proposed a bias correction scheme that consists in updating the bias terms of the layers with the difference between the expected quantized prediction and the original predictions. They achieved near full-precision accuracy in int8 quantization. Since this seminal work, two main categories of data-free quantization methods have emerged. First, data-generation based methods, that used samples generated by Generative Adversarial Networks (GANs) as samples to fine-tune the quantized model through knowledge distillation. Nevertheless, these methods are time-consuming and require significantly more computational resources. Other methods focus on improving the quantization operator but usually achieve lower accuracy. One limitation of these approaches is that they are essentially restricted to uniform quantization, while considering nonuniform mappings between the floating point and low-bit representation might be key to superior performance.

Indeed, in uniform settings, continuous variables are mapped to an equally-spaced grid in the original, floating point space. Such mapping introduces an error: however, applying such uniform mapping to an a priori non-uniform weight distribution is likely to be suboptimal in the general case. To circumvent this limitation, non-uniform quantization has been introduced. Two categories of non-uniform quantization approaches may be distinguished. First, methods that introduce a code-base and require very sophisticated implementations for actual inference benefits. Second, methods that simply modify the quantization operator. In particular, existing approaches have proposed a log-quantization technique. Similarly, existing approaches use log quantization with basis 2. In both cases, in practice, such logarithmic quantization scheme changes the nature of the mathematical operations involved, with multiplications being replaced by bit shifts. Nevertheless, one limitation of this approach is that because the very nature of the mathematical operations is intrinsically altered, in practice, it is hard to leverage without dedicated hardware and implementation. Instead of transforming floating point multiplications in integer multiplications, they change floating point multiplications into bit-shifts or even look up tables (LUTs). Some of these operations are very specific to some hardware (e.g. LUTs are thought for FPGAs) and may not be well supported on most hardware.

Within this context, there is a need for improved solutions for neural network quantization.

### SUMMARY

It is therefore provided a computer-implemented method for neural network quantization. The method comprises obtaining a neural network. The method further comprises obtaining a quantization operator. The quantization operator is based on a power function. The power function has a power exponent. The method further comprises quantizing the neural network based on the quantization operator. The quantization includes searching for an optimal value of the power exponent based on a quantization error associated with the quantization operator. This method may be referred to as “the quantization method”.

The quantization method may comprise one or more of the following:
searching for an optimal value of the power exponent includes:
   minimizing the quantization error; or
   determining a power exponent value compliant with the following criteria:
      minimization of the quantization error; and
      use a default power exponent, and/or minimization of a distance between the obtained neural network prior to quantization and the quantized neural network;
the quantization operator is of the type:

$${Q}_{a} : W ↦ ⌊ ( {2}^{b - 1} - 1 ) \frac{sign ( W ) \times {\vert W \vert}^{a}}{max {\vert W \vert}^{a}} ⌋ ,$$

where a∈ [symbol] is the power exponent, b is the number of bits associated with the quantization operator, W represents a tensor, and all operations are performed element wise;
the quantization error is of the type:

$$ϵ ( F , a ) = {\sum }_{l = 1}^{L} {‖ {W}_{l} - {Q}_{a}^{- 1} ( {Q}_{a} ( {W}_{l} ) ) ‖}_{p} ,$$

where ∥·∥ₚ denotes the L^{p} vector norm, {Wₗ, 1≤l≤L} represent the layers of the neural network, and Qₐ⁻¹ is the de-quantization operator and is of the type:

$${Q}_{a}^{- 1} ( W ) = sign ( W ) \times {\vert W \times \frac{max \vert W \vert}{{2}^{b - 1} - 1} \vert}^{\frac{1}{a}} ;$$

for at least one layer with a signed activation function Act with input x and weights W, Qₐ⁻¹(Qₐ(x+C_{Act})Qₐ(W)) is approximated by xW+C_{Act}W, C_{Act}W being a bias term;
the method comprises performing the quantization during a post-training calibration of the neural network;
performing the quantization during a post-training calibration of the neural network uses a gradient descent;
the method comprises performing the quantization by training the neural network, or by finetuning the neural network, the training comprising using power functions for quantization simulation;
the quantization using the quantization operator concerns at least a part of the layers of the neural network; and/or
during inference using the quantized neural networks, power of products (e.g. powers with exponent 1/a, where a is the power exponent) are accumulated instead of accumulating the quantized products.

It is also provided a computer-implemented method for performing multiplication of quantized matrices with a quantization operator. The quantization operator is based on a power function. The power function has a power exponent. The method comprises accumulating power of products. This method may be referred to as “the matrix multiplication method”.

It is further provided a quantized neural network obtainable according to the quantization method.

It is further provided a computer program comprising instructions for performing the quantization method and/or the matrix multiplication method.

It is further provided a device comprising a data storage medium having recorded thereon the computer program and/or the quantized neural network obtainable according to the quantization method.

The device may form or serve as a non-transitory computer-readable medium, for example on a SaaS (Software as a service) or other server, or a cloud based platform, or the like. The device may alternatively comprise a processor coupled to the data storage medium. The device may thus form a computer system in whole or in part (e.g. the device is a subsystem of the overall system). The system may further comprise a graphical user interface coupled to the processor.

### BRIEF DESCRIPTION OF THE DRAWINGS

Non-limiting examples will now be described in reference to the accompanying drawings, where:

FIGS. 1 to 3 illustrate the quantization method; and

FIG. 4 illustrates the computer system.

### DETAILED DESCRIPTION

It is provided a computer-implemented method for neural network quantization. The method comprises obtaining a neural network. The method further comprises obtaining a quantization operator. The quantization operator is based on a power function. The power function has a power exponent. The method further comprises quantizing the neural network based on the quantization operator. The quantization includes searching for an optimal value of the power exponent based on a quantization error associated with the quantization operator. As previously discussed, this method may be referred to as “the quantization method”.

The quantization method forms an improved solution for neural network quantization.

First of all, the method performs quantization of the input neural network (i.e. the obtained neural network). Thus, the method outputs a quantized neural network, i.e. weights and/or activation functions of the neural network are quantized, that is encoded with less bits than their initial encoding. This allows, during inference time, that is when the neural network is used for the task for which it has been trained, to perform computations (typically involving matrix multiplications) faster, more efficiently and with a reduced memory usage.

Furthermore, the method performs quantization with a quantization operator that is based on a power function. Such quantization operator preserves the multiplication, i.e. the quantization operator Q is such that

$$∀ x , y , {Q}^{- 1} ( Q ( x ) \times Q ( y ) ) = x \times y .$$

Thus, the quantization operator used in the method does not require specific hardware and/or inference engine due to non-preservation of the multiplication. For example, log quantification as previously discussed does not preserve the multiplication and transforms it into a bit-shift operation, which requires the use a specific inference engine (such as the known TensorRT or OpenVINO). This is not the case with the quantization performed by the method, for which multiplication is preserved. This allows to implement the method and/or to use the quantized neural network for inference on any available hardware (that is on any general hardware normally suitable for inference with a neural network) and/or without the need of a specific inference engine.

Moreover, not only does the method perform quantization with a quantization operator which is based on a power function, but the method does so using an optimal value of the power exponent of the power function. For that, the method searches for the optimal value of the power exponent. Then the method may perform the quantization using the determined optimal value for the power exponent. The search is based on the quantization error that is associated with the quantization operator, i.e. the method searches the value of the exponent so that the quantization error is small (e.g. minimized). This does not exclude the search to be based on other criteria, as explained hereinafter, but the search is based on the guiding principle of minimizing the quantization error, even if this minimization may be weighted by said other criteria. In any case, this search and use of the optimal power exponent value allows to perform the quantization with minimum or at least reduce quantization error, so that quality and accuracy of the quantized neural network, and thus of the inference, is maintained at least at an acceptable level. In other words, compared to existing quantized neural network, the neural network quantized by the quantization method does not require a specific inference engine and enhances the use of memory and computing resources, while having an improved accuracy for inference.

The neural network may be any neural network, for example any feed forward neural network. The neural network may be any neural network for computer vision, that is any neural network used in a computer vision task. For example, the neural network may be a neural network that performs car detection on an image or a video. Because inference with the neural network, once quantized by the quantization method, is resource-efficient and memory-efficient, and does not require any specific inference engine, inference with the quantized neural network may be performed directly locally using the camera chip. The method may further comprise using the quantized neural network for inference, that is applying the quantized and trained neural network for performing the inference time for which the neural network has been trained, for example car detection as previously discussed. Using the quantized network for inference may comprise using the matrix multiplication method for the inference matrix computations.

The quantization method is now further discussed.

The quantization method is for neural network quantization. This means that the method takes as input a neural network (i.e. the obtained neural network) and outputs a quantized version of this neural network, that is outputs the neural network having at least a part of (e.g. a strict part of or all of) its layers being quantized by the quantization operator used in the method. This also means that at least a part of (e.g. a strict part of or all of) the weights and/or the activation functions of the neural network are quantized by the quantization operator. For that, the method comprises quantizing the neural network. This includes the search for an optimal value of the power exponent as further discussed hereinafter. This may also include quantizing, at least in part, the neural network by applying the quantization operator with the optimal value for the power exponent.

Prior to the quantizing/quantization of the neural network, the method comprises obtaining the neural network and the quantization operator, which thus form inputs to the method. Obtaining the inputs may comprise retrieving (e.g. downloading) the inputs from an existing (e.g. distant) memory or server or database where the inputs are stored. Alternatively, obtaining the inputs may comprise creating at least in part the inputs (e.g. coding the quantization operator and/or training the neural network and/or initializing the neural network parameters).

The neural network may be obtained already trained, that is with all its weights and parameters being already set by an already executed training/learning. Alternatively, the neural network may be obtained not trained, and the method may comprise performing the training of the neural network (e.g. from scratch or from a pretrained state), or finetuning the neural network (e.g. from a pretrained state and/or with a different training dataset than the original training dataset) during the quantization. In other words, the method may comprise performing the quantization by training the neural network from scratch or from a pretrained state. or by finetuning the neural network (e.g. from a pretrained state and/or with a different training dataset than the original training dataset), in which case the training, or the finetuning, comprises, besides normal training operations, using power functions for quantization simulation. The latter means that the search for the optimal value of the power exponent is done during training and is based on quantization simulation(s) performed during the training to find the optimal value. Yet alternatively, the neural network may be obtained already trained, and the quantization may be performed during a post-training calibration of the neural network (post-training calibration being a concept known per se from machine learning). Performing the quantization during a post-training calibration of the neural network may use a gradient descent to search for the optimal power exponent value.

The quantization operator is an operator that performs quantization, i.e. that takes as input floating point values and maps them to a discrete space. The concept of quantization operator is known per se in the field of quantization. The quantization operator used in the method is based on a power function, that is the quantization operator performs quantization using the power function applied to the input of the operator. The quantization operator may for example perform quantization based on the combination of the power function and of the rounding operation. The power function has a power exponent. Such a quantization operator preserves the multiplication as explained above.

The motivation behind this choice of using a power function for the quantization operator is now discussed.

Let F be the neural network with L layers, each comprising a weight tensor Wₗ. Let Q be the quantization operator such that the quantized weights Q(Wₗ) are represented on b bits (such number b being then referred to as “the number of bits associated with the quantization operator). The most popular such operator is the uniform one. However, despite its simplicity, the choice of such a uniform operator is responsible for a significant part of the quantization error. In fact, the weights Wₗ. most often follow a bell-shaped distribution for which uniform quantization is ill-suited: intuitively, in such a case, one would want to quantize more precisely the small weights on the peak of the distribution. For this reason, the most popular non-uniform quantization scheme is logarithmic quantization, outputting superior performance. Practically speaking, however, it consists in replacing the quantized multiplications by bit-shift operations. As a result, these methods have limited adaptability as the increment speed is hardware dependent. To address this problem, the method uses a non-uniform quantization operator that preserve the nature of matrix multiplications. Formally, taking aside the rounding operation in quantization, the quantization operator is chosen in the space of functions Q of functions Q such that

$$∀ Q ∈ Q , ∃ {Q}^{- 1} ∈ Q s . t . ∀ x , y , {Q}^{- 1} ( Q ( x ) \times Q ( y ) ) = x \times y , \qquad ( 1 )$$

where × is the standard multiplication and Q, Q⁻¹ are the quantization and de-quantization operators, respectively.

Now, let Q be a transformation from [symbol] ₊ to [symbol] ₊ In this case, the equality in (1) becomes

$${Q}^{- 1} ( Q ( x ) \times Q ( y ) ) = x \times y ∀ x , y ∈ {ℝ}_{+}^{2}$$

In order to define a de-quantization operation, Q⁻¹ must be defined, i.e. Q is bijective. Thus, by definition, Q is a group automorphism of ( [symbol] ₊, ×). Thus, quantization operators that preserve the nature of multiplications are restricted to automorphisms of ( [symbol] ₊, ×). The following lemma further restricts the possible quantization operators to be based on power functions.

Lemma 1: The set of continuous automorphisms of ( [symbol] ₊, ×) is defined by the set of power functions Q={Q: x→x^{a}|a∈ [symbol] }.

A proof of Lemma 1 is given hereinafter.

In the above, a is referred to as “the power exponent” of the function x→x^{a}.

Thus, the quantization operator used in the method may be chosen within the set

$$Q = \{ {Q}_{a} : W ↦ ⌊ ( {2}^{b - 1} - 1 ) \frac{sign ( W ) \times {\vert W \vert}^{a}}{max {\vert W \vert}^{a}} ⌋ \vert a ∈ ℝ \} , \qquad ( 2 a )$$

which means that the quantization operator may be of the type (e.g. may be exactly):

$${Q}_{a} : W ↦ ⌊ ( {2}^{b - 1} - 1 ) \frac{sign ( W ) \times {\vert W \vert}^{a}}{max {\vert W \vert}^{a}} ⌋ \vert a ∈ ℝ , \qquad ( 2 b )$$

where a∈ [symbol] is the power exponent, b is the number of bits associated with the quantization operator, W represents a tensor, and all operations are performed element wise. As functions of W, the quantization operators defined in equations (2a)-(2b) are (signed) power functions.

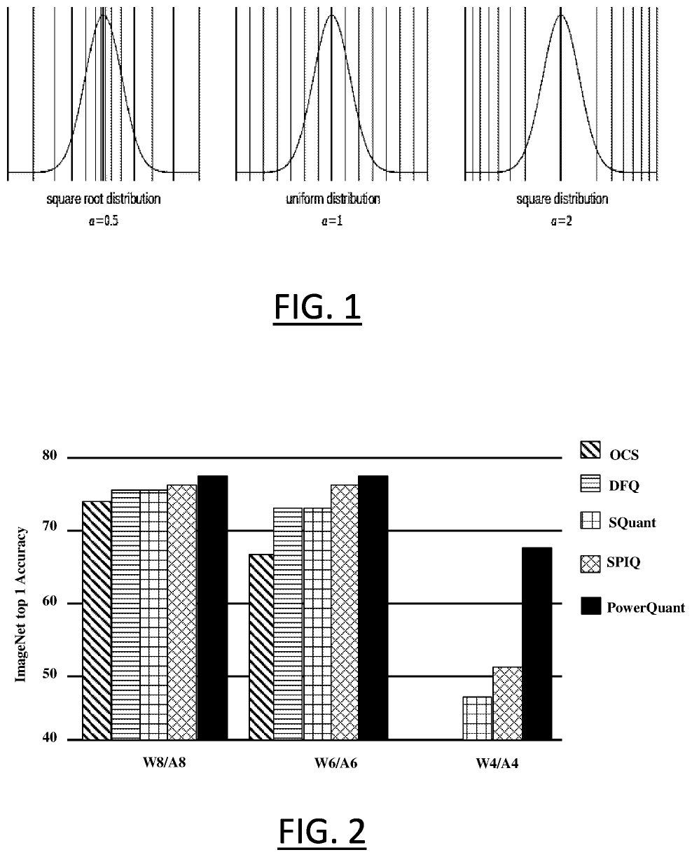

The quantization of the neural network according to the quantization method includes searching for an optimal value of the power exponent, i.e. searching for an optimal value of a∈ [symbol] . FIG. 1 illustrates the effect of the power parameter (power exponent) a on quantization (vertical bars). Uniform quantization and a=1 are equivalent and correspond to a quantization invariant to the weight distribution. For a<1, the quantization is more fine-grained on weight values with low absolute value and coarser on high absolute values. Conversely, for a>1, the quantization becomes more fine-grained on high absolute values.

The search for the optimal value is based on a quantization error associated with the quantization operator. The quantization error is any function that describes the error made by the quantization operator (as the latter is not a bijection), i.e. the error (disparity, discrepancy) between the input of the operator and its quantization. The search is thus performed with the purpose of minimizing the quantization error, i.e. the optimal value searched for needs to comply with the purpose of minimizing the error. In yet other words, the power exponent with the optimal value yields the quantization operator that aims a minimizing the quantization error. Thus, minimization of the quantization error is the general principle guiding the search. This does however not exclude this principle to be weighted by other search criteria.

For example, searching for an optimal value of the power exponent includes determining a power exponent value compliant with the following criteria:
minimization of the quantization error; and
use a default power exponent, and/or minimization of a distance between the obtained neural network prior to quantization and the quantized neural network.

Alternatively, searching for the optimal value may include minimizing the quantization error, that is the optimal value searched for is the one that minimizing the quantization error. This does not necessarily mean that the found value is the one that mathematically minimizing the quantization error: it may be, but it may also be the value that is the closest to this value minimizing the error, for example up to some convergence criterion or stop criterion of the minimization method. The search may thus include performing a minimization of the error with any suitable minimization method having the power exponent value as free variable, by using for example the Nelder-Mead method discussed in John A Nelder and Roger Mead, “A simplex method for function minimization”, The computer journal, 7 (4): 308-313, 1965, which is incorporated herein by reference.

The quantization error may be of the type (e.g. may be exactly):

$$ϵ ( F , a ) = {\sum }_{l = 1}^{L} {‖ {W}_{l} - {Q}_{a}^{- 1} ( {Q}_{a} ( {W}_{l} ) ) ‖}_{p} , \qquad ( 3 )$$

where ∥·∥ₚ denotes the L^{p} vector norm, {Wₗ, 1≤l≤L} represent the layers of the neural network, and Qₐ⁻¹ is the de-quantization operator and is of the type (e.g. may be exactly):

$${Q}_{a}^{- 1} ( W ) = sign ( W ) \times {\vert W \times \frac{max \vert W \vert}{{2}^{b - 1} - 1} \vert}^{\frac{1}{a}} . \qquad ( 4 )$$

The minimization of (3), that is finding the best exponent a*=argminₐ∈(F,a), is a locally convex optimization problem which has a unique minimum. The Nelder-Mead method, which solves problems for which derivatives may not be known or, in the present case, are almost-surely zero (due to the rounding operation), allows to solve this minimization problem. In practice, more recent solvers are not required in order to reach the optimal solution.

In examples, if the neural network comprises at least one layer with a signed activation function Act (such as SiLU, GeLU or PreLU) with input x and weights W, Qₐ⁻¹(Qₐ(x+C_{Act})Qₐ(W)) is approximated by xW+C_{Act}W, C_{Act}W being a bias term. By signed activation function, it is meant an activation function which has both negative and positive signs. Specifically, Based on equation (2a)-(2b), the quantization process of the weights necessitates the storage and multiplication of W along with a signs tensor, which is memory and computationally intensive. For the weights, however, this can be computed once during the quantization process, inducing no overhead during inference. As for activations, the sign of ReLU activations need not to be store as they are always positive. In this case, the power function has to be computed at inference time (see algorithm 2 below). However, it can be efficiently computed, using Newton's method to approximate continuous functions in integer-only arithmetic. This method is very efficient in practice as it converges in 2 steps for low bit representations (four steps for int32). Thus, the quantization method leads to significant accuracy gains with limited computational overhead. Conversely, for non-ReLU feed forward networks such as EfficientNets (SiLU) or Image Transformers (GeLU), activations are signed. This can be tackled using asymmetric quantization which consists in the use of a zero-point. In general, asymmetric quantization allows one to have a better coverage of the quantized values support. In the present case, asymmetric quantization is used to work with positive values only. Formally, for both SiLU and GeLU, the activations are analytically bounded below by C_{siLU}W=0.27846 and C_{GeLU}W=0.169971 respectively. Consequently, assuming a layer with a signed activation function Act with input x and weights W, the method may implement the following approximation:

$${Q}_{a}^{- 1} ( {Q}_{a} ( x + {C}_{Act} ) {Q}_{a} ( W ) ) \approx {( {( x + {C}_{Act} )}^{a} {W}^{a} )}^{\frac{1}{a}} = x W + {C}_{Act} W , \qquad ( 5 )$$

The bias term C_{SiLU}W induces a very slight computation overhead which is standard in asymmetric quantization. A detailed empirical evaluation of this cost is discussed hereinafter. Using the adequate value for the bias corrector, generalize equation (5) can be generalized to any activation function σ.

In implementations, the quantizing of the neural network according to the method may be performed by implementing algorithm 1 below:

Algorithm 1 Weight Quantization Algorithm

Require: trained neural network. F with L layers to quantize, number of bits b

| | |
|---|---|
| α ← solver(min{error(F,α)} | [symbol] in practice we use the Nelder-Mead |
| | method |

for l ∈ {1, ... , L} do

| | |
|---|---|
| W_{sign} ← sign(Wₗ) | [symbol] save the sign of the scalar values in W |
| Wₗ ← W_{sign} × \|Wₗ\| [symbol] | [symbol] power transformation |
| $s ← \frac{max ⌊ {W}_{l} ⌉}{{2}^{b - 1} - 1}$ | [symbol] get quantization scale |
| $Q : {W}_{l} ↦ ⌊ \frac{{W}_{l}}{s} ⌉ and$ | [symbol] qdefine Q and Q⁻¹ |

${Q}^{- 1} : W ↦ {W}_{sign} \times ⌊ W \times s ⌉ \text{?}$

end for

[symbol]

indicates data missing or illegible when filed

Inference with the quantized DNN may be performed in implementations with algorithm 2 below:

Algorithm 2 Simulated Inference Algorithm

Require: trained neural network F quantized with L layers, input X and exponent

[symbol]

| | |
|---|---|
| for l ∈ {1, ... , L} do | |
| X ← X [symbol] | [symbol] X is assumed positive (see equation ( [symbol] )) |
| X ← └X s_{X}┐ | [symbol] where s_{X} is a scale in the input range |
| [symbol] ← Fₗ (X^{Q}) | $⊳ where we applied \frac{\text{?}}{\text{?}} at the accumulation$ |
| $X ← ( \frac{\text{?} ( O )}{\text{?} X \text{?} W} )$ | [symbol] where σ is the activation function and s_{W} the weight scale |
| end for | |

[symbol]

indicates data missing or illegible when filed

Furthermore, the proposed representation is fully compatible with integer multiplication as defined in Benoit Jacob et. al., “Quantization and training of neural networks for efficient integer-arithmetic-only inference”, CVPR, pp. 2704-2713, 2018, which is incorporated herein by reference. Thus it is fully compatible with integer only inference.

The proposed quantization method may be referred to as “PowerQuant”. It is very efficient as it only requires simple modifications in the quantized DNN activation functions and accumulation. Furthermore, it is demonstrated below through extensive experimentation that the method achieves outstanding results on various and challenging benchmarks with negligible computational overhead. The method propose a non-uniform quantization scheme that preserves the nature of the mathematical operations by mapping floating point multiplications to standard integer multiplications. As a result, the method's approach boils down to simple modifications of the computations in the quantized DNN, hence allowing higher accuracies than uniform quantization methods while leading to straightforward, ready-to-use inference speed gains.

FIG. 2 already illustrates the improvements provided by PowerQuant (reference 50), and shows a comparison of the proposed method to other data-free quantization schemes on DenseNet 121 pretrained on ImageNet. The proposed method (reference 50) drastically improves upon the existing data-free methods especially in the challenging W4/A4 quantization.

### Experiments

Experiments to evidence the improvements brought by the proposed method are now discussed. First, it is discussed the optimization of the exponent parameter a of PowerQuant using the reconstruction error, showing its interest as a proxy for the quantized model accuracy from an experimental standpoint. It is shown that the proposed approach preserves this reconstruction error significantly better, allowing a closer fit to the original weight distribution through non-uniform quantization. Second, it is shown through a variety of benchmarks that the proposed approach significantly outperforms state-of-the-art data-free methods, thanks to more efficient power function quantization with optimized exponent. Third, it is shown that the proposed approach comes at a negligible cost in term of inference speed.

The proposed PowerQuant method is validated on ImageNet classification (≈1.2M images train/50 k test), discussed in J. Deng, W. Dong, et al., “ImageNet: A Large-Scale Hierarchical Image Database”, CVPR, 2009, which is incorporated herein by reference. In the experiments pre-trained MobileNets (Mark Sandler, Andrew Howard, et al., “Mobilenetv2: Inverted residuals and linear bottlenecks”, CVPR, pp. 4510-4520, 2018, which is incorporated herein by reference), ResNets (Kaiming He, Xiangyu Zhang, et al, “Deep residual learning for image recognition”, CVPR, pp. 770-778, 2016, which is incorporated herein by reference), EfficientNets (Mingxing Tan and Quoc V Le, “Efficientnet: Rethinking model scaling for convolutional neural networks”, ICML, pp. 6105-6114, 2019, which is incorporated herein by reference) and DenseNets (Gao Huang, Zhuang Liu, Laurens Van Der Maaten, and Kilian Q Weinberger, “Densely connected convolutional networks”, CVPR, pp. 4700-4708, 2017, which is incorporated herein by reference) are used. Tensorflow implementations of the baseline models from official repositories are used, achieving standard baseline accuracies. The quantization process was done using Numpy library. Activations are quantized as unsigned integers and weights are quantized using a symmetric representation. Batch-normalization layers are folded as described in Edouard Yvinec, Arnaud Dapogny, and Kevin Bailly, “To fold or not to fold: a necessary and sufficient condition on batch-normalization layers folding”, IJCAI, 2022a, which is incorporated herein by reference. Ablation study was performed using the uniform quantization operator over weight values from Raghuraman Krishnamoorthi, “Quantizing deep convolutional networks for efficient inference: A whitepaper”, arXiv preprint arXiv: 1806.08342, 2018, which is incorporated herein by reference, and logarithmic quantization from Daisuke Miyashita, Edward H Lee, and Boris Murmann, “Convolutional neural networks using logarithmic data representation”, arXiv preprint arXiv: 1603.01025, 2016, which is incorporated herein by reference. For the comparison with state-of-the-art approaches in data-free quantization, the more complex quantization operator from SQuant (Guo Cong, Qiu Yuxian, Leng Jingwen, Gao Xiaotian, Zhang Chen, Liu Yunxin, Yang Fan, Zhu, Yuhao, and Guo Minyi, “Squant: On-the-fly data-free quantization via diagonal hessian approximation”, ICLR, 2022,) which is incorporated herein by reference, was implemented. To compare with strong baselines, bias correction, which measures the expected difference between the outputs of the original and quantized models and updates the biases terms to compensate for this difference, was implemented, as well as input weight quantization (see Markus Nagel, Mart van Baalen, et al., “Data-free quantization through weight equalization and bias correction”, ICCV, pp. 1325-1334, 2019, which is incorporated herein by reference).

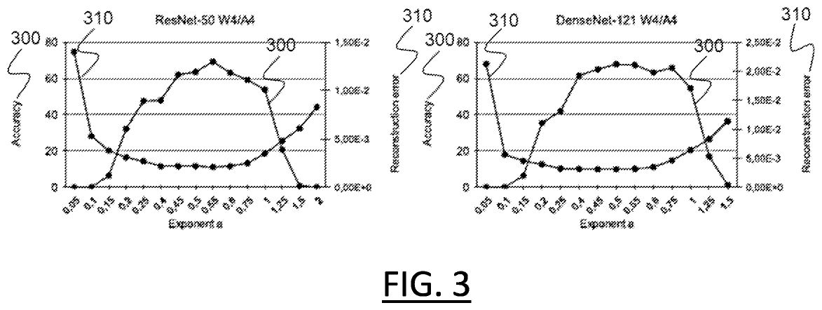

FIG. 3 illustrates the evolution of both the accuracy (300) of the whole DNN and the reconstruction error (310) summed over all the layers of the network, as functions of the exponent parameter a, for ResNet (left hand side) and DenseNet (right hand side) in W4/A4. The target is the highest accuracy with respect to the value of a: however, in a data-free context, one only has access to the reconstruction error. Nevertheless, as shown on FIG. 3, these metrics are strongly anticorrelated. Furthermore, while the reconstruction curve is not convex it behaves well for simplex based optimization method such as the Nelder-Mead method. This is due to two properties: locally convex (discussed hereinafter) and has a unique minimum (discussed hereinafter).

Empirically, optimal values a* for the exponent parameter are centered on 0.55, which approximately corresponds to the first distribution in FIG. 1. Still, as shown on Table 1 below, one observes some variations on the best value for a which motivates the optimization of a for each network and bitwidth. Furthermore, the results provide a novel insight on the difference between pruning and quantization. In the pruning literature, the baseline method consists in setting the smallest scalar weight values to zero and keeping unchanged the highest non-zero values, assuming that small weights contribute less to the network prediction. In a similar vein, logarithmic or power quantization with a>1 roughly quantizes (almost zeroing it out) small scalar values to better preserve the precision on larger values. In practice, in the present case, lower reconstruction errors, and better accuracies, are achieved by setting a<1: this suggests that the assumption behind pruning can't be straightforwardly applied to quantization, where in fact it can be argued that finely quantizing smaller weights is paramount to preserve the patterns learned at each layer, and the representation power of the whole network.

TABLE 1
Comparison between logarithmic, uniform and the proposed quantization
scheme on ResNet 50 trained for ImageNet classification task.
Report is done for different quantization configuration (weights
noted W and activations noted A) both the top1 accuracy and
the reconstruction error (equation (3)).

| | | | | | | Recon- |
|---|---|---|---|---|---|---|
| Archi- | | | | | | struction |
| tecture | Method | W-bit | A-bit | a* | Accuracy | Error |
| ResNet | Baseline | 32 | 32 | — | 76.15 | — |
| 50 | uniform | 8 | 8 | 1 | 76.15 | 1.1 × 10⁻⁴ |
| | logarithmic | 8 | 8 | — | 76.12 | 2.0 × 10⁻⁴ |
| | PowerQuant | 8 | 8 | 0.55 | 76.15 | 1.0 × 10⁻⁴ |
| | uniform | 4 | 4 | 1 | 54.68 | 3.5 × 10⁻³ |
| | logarithmic | 4 | 4 | — | 57.07 | 2.1 × 10⁻³ |
| | PowerQuant | 4 | 4 | 0.55 | 70.29 | 1.9 × 10⁻³ |

Another approach that puts more emphasis on the nuances between low valued weights is logarithmic based non-uniform quantization. In Table 1 and as discussed hereinbelow, the proposed power method has been compared to both uniform and logarithmic approaches. By definition, the proposed power method necessarily outperforms the uniform method in every scenario as uniform quantization is included in the search space. For instance, in int4, the proposed method improves the accuracy by 13.22 points on ResNet 50. This improvement can also be attributed to a better input quantization of each layer, especially on ResNet 50 where the gap in the reconstruction error (over the weights) is smaller.

In table 2 below, it is reported the performance of several data-free quantization approaches on ResNet 50. Although no real training data is involved in these methods, some approaches such as ZeroQ, DSG or GDFQ rely on data generation (DG) in order to calibrate parameters of the method or to apply fine-tuning to preserve the accuracy through quantization. As shown in table 2, in the W8/A8 setup, the proposed PowerQuant method outperforms other data-free solutions, fully preserving the accuracy of the floating point model. The gap is even wider on the more challenging low bit quantization W4/A4 setup, where the PowerQuant improves the accuracy by 1.93 points over SQuant and by 14.88 points over GDFQ. This shows the effectiveness of the method on ResNet 50. More results are provided on DenseNet, MobileNet, Efficient Net hereinafter. These results demonstrate the versatility of the method on both large and very compact convnets. In summary, the proposed PowerQuant vastly outperforms other data-free quantization schemes. Last but not least, when compared to recent QAT methods such as OCTAV, PowerQuant achieves competitive results on both ResNets and MobileNets using either both static or dynamic quantization. This is remarkable since PowerQuant does not involve any fine-tuning of the network. More details on this benchmark hereinafter. In what follows, PowerQuant is evaluated on recent transformer architectures for both image and language applications.

TABLE 2
Comparison between state-of-the-art post training quantization
techniques on ResNet 50 on ImageNet. Distinction is made
methods relying on data (synthetic or real) or not. In
addition to being fully data-free, the present approach
significantly outperforms existing methods.

| Archi- | | | W- | A- | | |
|---|---|---|---|---|---|---|
| tecture | Method | Data | bit | bit | Accuracy | gap |
| ResNet | Baseline | — | 32 | 32 | 76.15 | — |
| 50 | DFQ [symbol] [symbol] | No | 8 | 8 | 75.45 | −0.70 |
| | ZeroQ [symbol] [symbol] | Synthetic | 8 | 8 | 75.89 | −0.26 |
| | DSG [symbol] [symbol] | Synthetic | 8 | 8 | 75.87 | −0.28 |
| | GDFQ [symbol] (2020) | Synthetic | 8 | 8 | 75.71 | −0.44 |
| | SQuant [symbol] [symbol] | No | 8 | 8 | 76.04 | −0.11 |
| | PowerQuant | No | 8 | 8 | 76.15 | 0.00 |
| | DFQ [symbol] [symbol] | No | 4 | 4 | 0.10 | −76.05 |
| | ZeroQ [symbol] [symbol] | Synthetic | 4 | 4 | 7.75 | −68.40 |
| | DSG [symbol] [symbol] | Synthetic | 4 | 4 | 23.10 | −53.05 |
| | GDFQ [symbol] (2020) | Synthetic | 4 | 4 | 55.65 | −20.50 |
| | SQuant [symbol] [symbol] | No | 4 | 4 | 68.60 | −7.55 |
| | PowerQuant | No | 4 | 4 | 70.53 | −5.62 |

In Table 3 below, the weight tensors of a ViT have been quantized with 85M parameters and baseline accuracy ≈78 as well as DeiT T, S and B with baseline accuracies 72.2, 79.9 and 81.8 and ≈5M, ≈22M, ≈87M parameters respectively. Similarly to ConvNets, the image transformer is better quantized using PowerQuant rather than standard uniform quantization schemes such as DFQ. Furthermore, more complex and recent data-free quantization schemes such as SQuant, tend to under-perform on the novel Transformer architectures as compared to ConvNets. This is not the case for PowerQuant which maintains its very high performance even in low bit representations. This is best illustrated on VIT where PowerQuant W4/A8 out performs both DFQ and SQuant even when they are allowed 8 bits for the weights (W8/A8) by a whopping 4.91 points. The proposed PowerQuant even outperforms methods dedicated to transformer quantization such as PSAQ on every image transformer tested. The proposed power quantization, in W4/A8, on natural language processing (NLP) tasks has been further compared and report results in Table 4 below. A BERT model has been evaluated on GLUE and report both the original (reference) and the reproduced (baseline) results. The three quantization processes are compared: uniform, logarithmic and PowerQuant. Similarly to computer vision tasks, the power quantization outperforms the other methods in every instances which further confirms its ability to generalize well to transformers and NLP tasks. In what follows, it is shown experimentally that the proposed approach induces very negligible overhead at inference time, making this accuracy enhancement virtually free from a computational standpoint.

TABLE 3
Comparison of data-free quantization methods
on ViT and DeiT trained on ImageNet.

| | | | |
|---|---|---|---|
| model | method | W/A | accuracy |

(a) Evaluation for ViT Base

| | | | |
|---|---|---|---|
| ViT | baseline | —/— | 78.05% |
| | DFQ (ICCV 2019) | 8/8 | 70.33% |
| | SQuant (ICLR 2022) | 8/8 | 68.85% |
| | PSAQ (arxiv 2022) | 8/8 | 37.36% |
| | PowerQuant | 8/8 | 77.46% |
| | DFQ (ICCV 2019) | 4/8 | 66.63% |
| | SQuant (ICLR 2022) | 4/8 | 64.62% |
| | PSAQ (arxiv 2022) | 4/8 | 25.34% |
| | PowerQuant | 4/8 | 75.24% |

(b) Evaluation for DeiT Tiny

| | | | |
|---|---|---|---|
| DeiT T | baseline | —/— | 72.21% |
| | DFQ (ICCV 2019) | 8/8 | 71.32% |
| | SQuant (ICLR 2022) | 8/8 | 71.11% |
| | PSAQ (arxiv 2022) | 8/8 | 71.56% |
| | PowerQuant | 8/8 | 72.23% |
| | DFQ (ICCV 2019) | 4/8 | 67.71% |
| | SQuant (ICLR 2022) | 4/8 | 67.58% |
| | PSAQ (arxiv 2022) | 4/8 | 65.57% |
| | PowerQuant | 4/8 | 69.77% |

(c) Evaluation for DeiT Small

| | | | |
|---|---|---|---|
| DeiT S | baseline | —/— | 79.85% |
| | DFQ (ICCV 2019) | 8/8 | 78.76% |
| | SQuant (ICLR 2022) | 8/8 | 78.94% |
| | PSAQ (arxiv 2022) | 8/8 | 76.92% |
| | PowerQuant | 8/8 | 79.33% |
| | DFQ (ICCV 2019) | 4/8 | 76.75% |
| | SQuant (ICLR 2022) | 4/8 | 76.61% |
| | PSAQ (arxiv 2022) | 4/8 | 73.23% |
| | PowerQuant | 4/8 | 78.16% |

(d) Evaluation for DeiT Base

| | | | |
|---|---|---|---|
| DeiT B | baseline | —/— | 81.85% |
| | DFQ (ICCV 2019) | 8/8 | 80.72% |
| | SQuant (ICLR 2022) | 8/8 | 80.60% |
| | PSAQ (arxiv 2022) | 8/8 | 79.10% |
| | PowerQuant | 8/8 | 81.26% |
| | DFQ (ICCV 2019) | 4/8 | 79.41% |
| | SQuant (ICLR 2022) | 4/8 | 79.21% |
| | PSAQ (arxiv 2022) | 4/8 | 77.05% |
| | PowerQuant | 4/8 | 80.67% |

TABLE 4
Complementary Benchmarks on the GLUE task with the BERT transformer
architecture quantized in W4/A8. The original performance (from the
article) is provided as well as the reproduced results (baseline).

| task | original | baseline | uniform | log | SQuant | PowerQuant |
|---|---|---|---|---|---|---|
| CoLA | 49.23 | 47.90 | 45.60 | 45.67 | 46.88 | 47.11 |
| SST-2 | 91.97 | 92.32 | 91.81 | 91.53 | 91.09 | 92.23 |
| MRPC | 89.47/85.29 | 89.32/85.41 | 88.24/84.49 | 86.54/82.69 | 88.78/85.24 | 89.26/85.34 |
| STS-B | 83.95/83.70 | 84.01/83.87 | 83.89/83.85 | 84.01/83.81 | 83.80/83.65 | 84.01/83.87 |
| QQP | 88.40/84.31 | 90.77/84.65 | 89.56/83.65 | 90.30/84.04 | 90.34/84.32 | 90.61/84.45 |
| MNLI | 80.61/81.08 | 80.54/80.71 | 78.96/79.13 | 78.96/79.71 | 78.35/79.56 | 79.02/80.28 |
| QNLI | 87.46 | 91.47 | 89.36 | 89.52 | 90.08 | 90.23 |
| RTE | 61.73 | 61.82 | 60.96 | 60.46 | 60.21 | 61.45 |
| WNLI | 45.07 | 43.76 | 39.06 | 42.19 | 42.56 | 42.72 |

The ACE metrics was recently introduced in Yichi Zhang, Zhiru Zhang, and Lukasz Lew, “Pokebnn: A binary pursuit of lightweight accuracy”, In CVPR, pp. 12475-12485, 2022, which is incorporated herein by reference, to provide a hardware-agnostic measurement of the overhead computation cost in quantized neural networks. In Table 5 below, the cost in the inference graph due to the change in the activation function is evaluated. It is observed very similar results to Table 17 (discussed hereinbelow). The proposed changes are negligible in terms of computational cost on all tested networks. Furthermore, DenseNet has the highest cost due to its very dense connectivity. On the other hand, using this metric it seems that the overhead cost due to the zero-point technique previously discussed for EfficientNet has no significant impact as compared to MobileNet and ResNet. In addition, the inference and processing cost of PowerQuant on specific hardware using dedicated tools is discussed hereinafter.

TABLE 5
ACE cost of the overhead computations
introduced by PowerQuant.

| Architecture | overhead cost | accuracy in W6/A6 |
|---|---|---|
| ResNet 50 | 0.63% | 75.07 |
| DenseNet 121 | 0.97% | 72.71 |
| MobileNet V2 | 0.57% | 52.20 |
| EfficientNet B0 | 0.80% | 58.24 |

Thus, the proposed method addresses the problem of the uniformity of the quantization as a limitation of existing datafree methods. To address this limitation, the present disclosure proposes a novel data-free method for non-uniform quantization of trained neural networks for computer vision tasks, with an emphasis on not changing the nature of the mathematical operations involved (e.g. matrix multiplication). This us to search among the continuous automorphisms of ( [symbol] ₊*, ×) which are restricted to the power functions x→x^{a}. The present disclosure proposes an optimization of this exponent parameter based upon the reconstruction error between the original floating point weights and the quantized ones. It is shown herein that this procedure is locally convex and admits a unique solution. At inference time, the proposed approach, dubbed PowerQuant, involves only very simple modifications in the quantized DNN activation functions. It is herein empirically demonstrated that PowerQuant allows a closer fit to the original weight distributions compared with uniform or logarithmic baselines, and significantly outperforms existing methods in a variety of benchmarks with only negligible computational overhead at inference time. In addition, it is also discussed and addressed herein some of the limitations in terms of optimization (per-layer or global) and generalization (non-ReLU networks). Future work may involve the search of an improved proxy error as compared with the proposed weight reconstruction error as well as the extension of the search space to other composition laws of [symbol] ₊ that are suited for efficient calculus and inference.

### Proof of Lemma 1

A proof of lemma 1 as well as a discussion on the continuity hypothesis is now given.
Proof. We have that ∀x∈ [symbol] ₊, Q(x)×Q(0)=Q(0) and ∀x∈ [symbol] , Q(x)×Q(1)=Q(x) which induces that Q is either the constant 1 or Q(0)=0 and Q(1)=1. Because Q is an automorphism we can eliminate the first option. Now, we will demonstrate that Q is necessarily a power function. Let n be an integer, then

$$Q ( {x}^{n} ) = Q ( x ) \times Q ( {x}^{n - 1} ) {Q ( \text{?} )}^{2} \times Q ( {x}^{n - 2} ) = … = {Q ( x )}^{n} . \qquad ( 6 )$$

$$\text{?} \text{indicates text missing or illegible when filed}$$

Similarly, for fractions, we get

$$Q ( {x}^{a} ) = {Q ( x )}^{a} \qquad ( 7 )$$

Assuming Q is continuous, we deduce that fix any rational a∈ [symbol] , we have

$$Q ( {x}^{\frac{1}{n}} ) \times … \times Q ( {x}^{\frac{1}{n}} ) = Q ( x ) ⇔ Q ( {x}^{\frac{1}{n}} ) = {Q ( x )}^{\frac{1}{n}} .$$

In order to verify that the solution is limited to power functions, we use a reductio ad absurdum. Assume Q is not a power function. Therefore, there exists (x,y)∈ [symbol] ₊^{b} and a∈ [symbol] such that Q(x)≠x^{a} and Q(y)=y^{a}. By definition of the logarithm, there exists b such that x^{b}=y. We get the following contradiction, from [symbol] ,

$$\{ \begin{matrix}Q ( {x}^{{b}^{a}} ) = Q ( {y}^{a} ) = {y}^{a} \\ Q ( {x}^{{b}^{a}} ) = Q ( {x}^{ab} ) = {Q ( {x}^{a} )}^{b} \neq ( {x}^{ab} = {y}^{a} )\end{matrix} \qquad ( 8 )$$

Consequently, the suited functions Q are limited to power functions i.e.

$$Q = \{ Q : x ↦ {x}^{a} \vert a {∈}_{□} ℝ \} .$$

It is to be noted that there are other Automorphisms of ( [symbol] , ×). However, the construction of such automorphisms require the axiom of choice. Such automorphisms are not applicable in the present case which is why the key constraint is being an automorphism rather than the continuous property.

### Norm Selection

In the minimization objective, we need to select a norm to apply. In this section, we provide theoretical arguments in favor of the l² vector norm. Let P be a feed forward neural network with L layers to quantize, each defined by a set of weights Wₗ=(wₗ)_{i,j}∈ [symbol] ⁿ^{ₗ}^{×m}^{ₗ} and bias bₗ∈ [symbol] ⁿ^{ₗ}. We note (λₗ^{(e)}), the eigenvalues associated with Wₗ. We want to study the distance d(F, Fₐ) between the predictive function F and its quantized version Fₐ defined as

$$d ( F , {F}_{a} ) = {max}_{x ∈ D} {‖ F ( x ) - {F}_{a} ( x ) ‖}_{p} \qquad ( 9 )$$

where [symbol] is the domain of F. We prove that minimizing the reconstruction error with respect to a is equivalent to minimizing d(F, Fₐ) with respect to a. Assume L=1 for the sake of simplicity and we drop the notation l. With the proposed PowerQuant method, we minimize the vector norm

$${‖ W - {Q}_{a}^{- 1} ( {Q}_{a} ( W ) ) ‖}_{p}^{p} = {\sum }_{i <= n} {max}_{j <= m} {\vert {w}_{i , j} - {Q}_{a}^{- 1} ( {Q}_{a} ( {w}_{i , j} ) ) \vert}^{p} \qquad ( 10 )$$

For p=2, the euclidean norm is equal to the spectral norm, thus minimizing ∥W−Qₐ⁻¹(Qₐ⁻¹(Qₐ(W))∥₂ is equivalent to minimizing d(F, Fₐ) for L=1. However, we know that minimizing for another value of p may result in a different optimal solution and therefore not necessarily minimize d(F, Fₐ).
In the context of data-free quantization, we want to avoid uncontrollable changes on F, which is why we recommend the use of p=2.

### Mathematical Property 1: Local Convexity

We prove that the minimization problem defined in equation [symbol] is locally convex around the solution a*. Formally we prove that

$$x ↦ {‖ x - {Q}_{a}^{- 1} ( {Q}_{a} ( x ) ) ‖}_{p} \qquad ( 11 )$$

is locally convex around a* defined as arg minₐ∥x−Qₐ⁻¹(Qₐ(x))∥ₚ.
Lemma 2. The minimization problem defined as

$$arg {min}_{a} \{ {‖ x - {Q}_{a}^{- 1} ( {Q}_{a} ( x ) ) ‖}_{p} \} \qquad ( 12 )$$

is locally convex around any solution a*.
Proof. We recall that

$$\frac{\text{?} {x}^{2}}{\text{?} a} = {x}^{a} log ( x ) .$$

$$\text{?} \text{indicates text missing or illegible when filed}$$

The function ∥x−Qₐ⁻¹(Qₐ(x))∥ is differentiable. We assume x∈ [symbol] , then we can simplify the sign functions (assume x positive without loss of generality) and note y=max|x|, then

$$\frac{\partial {Q}_{a}^{- 1} ( {Q}_{a} ( x ) )}{\partial a} = \frac{\partial {\vert ⌊ ( {2}^{b - 1} - 1 ) \frac{{x}^{a}}{{y}^{a}} ⌋ \frac{{y}^{a}}{{2}^{b - 1} - 1} \vert}^{\frac{1}{a}}}{\partial a} . \qquad ( 13 )$$

This simplifies to

$$\frac{\partial {Q}_{a}^{- 1} ( {Q}_{a} ( x ) )}{\partial a} = y \frac{\partial {( \frac{⌊ {B ( \frac{x}{y} )}^{a} ⌋}{B} )}^{\frac{1}{a}}}{\partial a} , \qquad ( 14 )$$

with B=2^{k . . . 1}−1. By using the standard differentiation rules, we know that the rounding operator has a zero derivative a.e. Consequently we get,

$$\frac{\partial {Q}_{a}^{- 1} ( {Q}_{a} ( z ) )}{\partial a} = - {a}^{2} {y ( \frac{⌊ {B ( \frac{x}{y} )}^{a} ⌋}{B} )}^{\frac{1}{a}} log ( \frac{⌊ {B ( \frac{x}{y} )}^{a} ⌋}{B} ) . \qquad ( 15 )$$

From this expression, we derive the second derivative, using the property (f∘g)″=f″∘g×g″+f′∘g×g″ and the derivatives

$${\vert \cdot \vert}^{{\frac{1}{p}}^{′}} = \frac{\text{?} {\vert x \vert}^{\frac{1}{p} - 2}}{p} and {\vert \cdot \vert}^{{\frac{1}{p}}^{″}} = \frac{1 - p}{\text{?}} \frac{{\vert z \vert}^{\frac{1}{p}}}{\text{?}} ,$$

$$\text{?} \text{indicates text missing or illegible when filed}$$

then for any xₛ∈x

$$\frac{{\partial }^{2} \vert {x}_{i} - {Q}_{a}^{- 1} ( {Q}_{a} ( {x}_{i} ) ) \vert}{\partial {a}^{2}} = \frac{1 - p}{{p}^{2}} \frac{{\vert {x}_{i} - {Q}_{a}^{- 1} ( {Q}_{a} ( {x}_{i} ) \vert}^{\frac{1}{p}}}{( {x}_{i} - {{Q}_{a}^{- 1} ( {Q}_{a} ( {x}_{i} ) )}^{2}} {( \frac{\partial {Q}_{a}^{- 1} ( {Q}_{a} ( x ) )}{\partial a} )}^{2} + \frac{( {x}_{i} - {Q}_{a}^{- 1} ( {Q}_{a} ( {x}_{i} ) ) {\vert {x}_{i} - {Q}_{a}^{- 1} ( {Q}_{a} ( {x}_{i} ) \vert}^{\frac{1}{p} - 2}}{p} \frac{{\partial }^{2} {Q}_{a}^{- 1} ( {Q}_{a} ( x ) )}{\partial {a}^{2}} \qquad ( 17 )$$

We now note the first term in the previous addition

$${T}_{1} = \frac{1 - p}{{p}^{2}} \frac{\vert \text{?} - {{Q}_{a}^{- 1} ( {Q}_{a} ( {x}_{i} ) )}^{\frac{1}{p}}}{( \text{?} - {{Q}_{a}^{- 1} ( {Q}_{a} ( {x}_{i} ) )}^{2}} {( \frac{\partial {Q}_{a}^{- 1} ( {Q}_{a} ( x ) )}{\text{?}} )}^{2}$$

$$\text{?} \text{indicates text missing or illegible when filed}$$

and the second term as a product of

$${T}_{2} = \frac{( {x}_{\text{?}} - {Q}_{\text{?}}^{- 1} ( {Q}_{\text{?}} ( {x}_{\text{?}} ) ) \vert {x}_{\text{?}} - {{Q}_{\text{?}}^{- 1} ( {Q}_{\text{?}} ( {x}_{\text{?}} ) )}^{\frac{1}{p} - 2}}{p} times {T}_{3} = {( \frac{{\text{?}}^{2} {Q}_{\text{?}}^{- 1} ( {Q}_{\text{?}} ( x ) )}{\text{?} {a}^{2}} )}^{2} .$$

$$\text{?} \text{indicates text missing or illegible when filed}$$

We know that T₁>0 and T₂>0, consequently, and T₂ is continuous in a. At a* the terms with |x₁−Qₐ⁻¹(Qₐ(xᵢ))| are negligible in comparison with

$$\frac{{\text{?}}^{2} {Q}_{\text{?}}^{- 1} ( {Q}_{\text{?}} ( x ) )}{\text{?} {a}^{2}} and {( \frac{\text{?} {Q}_{\text{?}}^{- 1} ( {Q}_{\text{?}} ( x ) )}{\text{?} a} )}^{2} .$$

$$\text{?} \text{indicates text missing or illegible when filed}$$

Consequently, there exists an open set around a* where

$${T}_{1} > \vert {T}_{2} \vert {T}_{3} , and \frac{\text{?} [ {x}_{\text{?}} - {Q}_{\text{?}}^{- 1} ( {Q}_{\text{?}} ( {x}_{\text{?}} ) ) ]}{\text{?} {a}^{\text{?}}} > {0.}_{}$$

$$\text{?} \text{indicates text missing or illegible when filed}$$

This concludes the proof.

### Mathematical Property 2: Uniqueness of Solution

In this section we provide the elements of proof on the uniqueness of the solution of the minimization of the quantization reconstruction error.
Lemma 3. The minimization problem over x∈ [symbol] ^{N} defined as

$$arg {min}_{\text{?}} \{ {‖ x - {Q}_{\text{?}}^{- 1} ( {Q}_{\text{?}} ( x ) ) ‖}_{p} \}$$

$$\text{?} \text{indicates text missing or illegible when filed}$$

has almost surely a unique global minimum a*.
Proof. We assume that x can not be exactly quantized, i.e. minₐ{∥x−Qₐ⁻¹(Qₐ(x))∥ₚ}>0 which is true almost everywhere. We use a reductio ad absurdum and assume that there exist two optimal solutions a₁ and a₂ to the optimization problem. We expand the expression ∥x−Qₐ⁻¹(Qₐ(x))∥ₚ and get

$${‖ x - {Q}_{a}^{- 1} ( {Q}_{\text{?}} ( \text{?} ) ) ‖}_{p} = ‖ x - {\vert ⌊ ( {2}^{b - 1} - 1 ) \frac{sign ( x ) \times {\vert x \vert}^{\text{?}}}{max {\vert x \vert}^{\text{?}}} ⌋ \frac{max {\vert x \vert}^{\text{?}}}{{2}^{b - 1} - 1} \vert}^{\frac{1}{a}} sign ( x ) ‖ . p \qquad ( 19 )$$

$$\text{?} \text{indicates text missing or illegible when filed}$$

We note the rounding term Rₐ and get

$${‖ x - {Q}_{a}^{- 1} ( {Q}_{\text{?}} ( \text{?} ) ) ‖}_{p} = {‖ x - {\vert {R}_{\text{?}} \frac{max {\vert x \vert}^{a}}{{2}^{b - 1} - 1} \vert}^{\frac{1}{a}} sign ( x ) ‖}_{p} . \qquad ( 20 )$$

$$\text{?} \text{indicates text missing or illegible when filed}$$

Assume Rₐ₁=Rₐ₂=R, the minimization problem arg minₐ

$${‖ x - {\vert R \frac{max {\vert x \vert}^{a}}{{2}^{b - 1} - 1} \vert}^{\frac{1}{a}} sign ( x ) ‖}_{p}$$

convex and has a unique solution, thus a₁=a₂. Now assume Rₐ₁≠Rₐ₂.

$$⌊ ( {2}^{b - 1} - 1 ) \frac{sign ( x ) \times {\vert x \vert}^{a}}{max {\vert x \vert}^{a}} ⌋ = R .$$

If there is a value a outside of D(Rₐ₁)∪D(Rₐ₂) such that R′ has each of its coordinate strictly between the coordinates of Rₐ₁ and Rₐ₂, then, without loss of generality, assume that at least half of the coordinates of Rₐ₁ are further away from the corresponding coordinates of x than one quantization step. This implies that there exists a value of a′ in D(R′) such that ∥x−Q_{a′}⁻¹(Q_{a′}(x))∥ₚ<∥x−Qₐ₂⁻¹(Qₐ₂(x))∥ₚ, which goes against our hypothesis. Thus, there are up to N possible values for R that minimize the problem which happens iff x satisfies at least one coordinate can be either ceiled or floored by the rounding. The set defined by this condition has a zero measure.

### Solver for Minimization

In this disclosure it is disclosed that Nelder-Mead solver may be used to find the optimal a*, as previously discussed. However, several other solvers may be used and have been tested by the inventors, as reported the results in Table 6 below. The empirical results show that basically any popular solver can be used, and that the Nelder-Mead solver is sufficient for the minimization problem.

TABLE 6
Minimization of the reconstruction error on a MobileNet
V2 for W6/A6 quantization with different solvers.

| Solver | a* | reconstruction error | accuracy |
|---|---|---|---|
| Nelder-Mead | 0.730 | 1.12 | 64.238 |
| Powell ( [symbol] , [symbol] ) | 0.744 | 1.10 | 64.104 |
| COBYLA ( [symbol] , [symbol] ) | 0.752 | 1.11 | 64.364 |

### Comparison Between LOG, NAÏVE, and POWER QUANTIZATION, Complementary Results

To complement the results provided herein on ResNet 50, it is listed in Table 7 below more quantization setups on ResNet 50 as well as DenseNet 121. To put it in a nutshell, the proposed power quantization systematically achieves significantly higher accuracy and lower reconstruction error than the logarithmic and uniform quantization schemes. On a side note, the poor performance of the logarithmic approach on DenseNet 121 can be attributed to the skewness of the weight distributions. Formally, ResNet 50 and DenseNet 121 weight values show similar average standard deviations across layers (0.0246 and 0.0264 respectively) as well as similar kurtosis (6.905 and 6.870 respectively). However their skewness are significantly different: 0.238 for ResNet 50 and more than twice as much for DenseNet 121, with 0.489. The logarithmic quantization, that focuses on very small value is very sensible to asymmetry which explains the poor performance on DenseNet 121. In contrast, the proposed method offers a robust performance in all situations.

TABLE 7
Comparison between logarithmic, uniform and the proposed
quantization scheme on ResNet 50 and DenseNet 121 trained
for ImageNet classification task. Report is done for
different quantization configuration (weights noted
W and activations noted A) both the top1 accuracy and
the reconstruction error (equation 3).

| | | | | | | Recon- |
|---|---|---|---|---|---|---|
| Archi- | | | | | | struction |
| tecture | Method | W-bit | A-bit | a* | Accuracy | Error |
| ResNet 50 | Baseline | 32 | 32 | — | 76.15 | — |
| | uniform | 8 | 8 | 1 | 76.15 | 1.1 × 10⁻⁴ |
| | logarithmic | 8 | 8 | — | 76.12 | 2.0 × 10⁻⁴ |
| | PowerQuant | 8 | 8 | 0.55 | 76.15 | 1.0 × 10⁻⁴ |
| | uniform | 6 | 6 | 1 | 75.07 | 8.0 × 10⁻⁴ |
| | logarithmic | 6 | 6 | — | 75.37 | 4.6 × 10⁻⁴ |
| | power (ours) | 6 | 6 | 0.50 | 75.95 | 4.3 × 10⁻⁴ |
| | uniform | 4 | 4 | 1 | 54.68 | 3.5 × 10⁻³ |
| | logarithmic | 4 | 4 | — | 57.07 | 2.1 × 10⁻³ |
| | PowerQuant | 4 | 4 | 0.55 | 70.29 | 1.9 × 10⁻³ |
| DenseNet | Baseline | 32 | 32 | — | 75.00 | — |
| 121 | uniform | 8 | 8 | 1 | 75.00 | 2.8 × 10⁻⁴ |
| | logarithmic | 8 | 8 | — | 74.91 | 2.5 × 10⁻⁴ |
| | PowerQuant | 8 | 8 | 0.60 | 75.00 | 2.2 × 10⁻⁴ |
| | uniform | 6 | 6 | 1 | 74.47 | 1.1 × 10⁻³ |
| | logarithmic | 6 | 6 | — | 72.71 | 1.0 × 10⁻³ |
| | power (ours) | 6 | 6 | 0.50 | 74.84 | 0.7 × 10⁻³ |
| | uniform | 4 | 4 | 1 | 54.83 | 4.7 × 10⁻³ |
| | logarithmic | 4 | 4 | — | 5.28 | 4.8 × 10⁻³ |
| | PowerQuant | 4 | 4 | 0.55 | 68.04 | 3.1 × 10⁻³ |

### Matrix Multiplication With the Proposed Quantization Method (PowerQuant)

The proposed PowerQuant method preserves the multiplication operations, i.e. a multiplication in the floating point space remains a multiplication in the quantized space (integers). This allows one to leverage current implementations of uniform quantization available on most hardware, as discussed for example in reference Amir Gholami, Sehoon Kim, Zhen Dong, Zhewei Yao, Michael W Mahoney, and Kurt Keutzer, “A survey of quantization methods for efficient neural network inference”, arXiv preprint arXiv: 2103.13630, 2021, and Shuchang Zhou, Yuxin Wu, Zekun Ni, Xinyu Zhou, He Wen, and Yuheng Zou, “Dorefa-net: Training low bitwidth convolutional neural networks with low bitwidth gradients”, arXiv preprint arXiv: 1606.06160, 2016, which are both incorporated herein by reference. However, while PowerQuant preserves multiplications it doesn't preserve additions which are significantly less costly than multiplications. Consequently, in order to infer under the PowerQuant transformation, instead of accumulating the quantized products, as done in standard quantization (as discussed for example in Benoit Jacob, Skirmantas Kligys, Bo Chen, Menglong Zhu, Matthew Tang, Andrew Howard, Hartwig Adam, and Dmitry Kalenichenko, “Quantization and training of neural networks for efficient integer-arithmetic-only inference”, CVPR, pp. 2704-2713, 2018, which is incorporated herein by reference), one may to accumulate the powers of said products. Formally, let's consider two quantized weights w₁, w₂ and their respective quantized inputs x₁, x₂. The standard accumulation may be performed as follows w₁x₁+w₂w₂. In the case of PowerQuant, this may be done as

$${( {w}_{1} {x}_{1} )}^{\frac{1}{a}} + {( {w}_{2} {w}_{2} )}^{\frac{1}{a}} .$$

Previous studies on quantization have demonstrated that such power functions can be computed with very high fidelity at almost no latency cost (as discussed for example in Sehoon Kim, Amir Gholami, Zhewei Yao, Michael W Mahoney, and Kurt Keutzer, “I-bert: Integeronly bert quantization”, In International conference on machine learning, pp. 5506-5518. PMLR, 2021, which is incorporated herein by reference.

In other words, during inference using the quantized neural networks, power of products may be accumulated instead of accumulating the quantized products. It is also proposed computer-implemented method for performing multiplication of quantized matrices with a quantization operator that is based on a power function having a power exponent, the method comprising accumulating power of products. This method may be referred to as “the matrix multiplication method”, as previously discussed.

### Overhead Cost of Zero-Points in Activation Quantization

The overhead cost introduced in equation 5 is well known in general in quantization as it arises from asymmetric quantization. Nonetheless, it is disclosed in the tables below some empirical values.

TABLE 8
Overhead induced by asymmetric quantization

| Architecture | parameters overhead | run-time overhead (CPU intel-m3) |
|---|---|---|
| ReaNet50 | 0.25% | 4.35% |
| EfficientNet | 0.20% | 3.38% |
| ViT b16 | 0.73% | 5.14% |

TABLE 9
Comparison between the per-layer and global method
of power parameter a fitting on a ResNet 5a
trained for ImageNet classification task.

| | | | | | Reconstruction |
|---|---|---|---|---|---|
| Architecture | Method | W-bit | A-bit | Accuracy | Error |
| ResNet 50 | Baseline | 32 | 32 | 76.15 | — |
| | per-layer | 8 | 8 | 76.14 | 0.8 × 10⁻⁴ |
| | global | 8 | 8 | 76.15 | 1.0 × 10⁻⁴ |
| | per-layer | 4 | 4 | 64.19 | 1.7 × 10⁻³ |
| | global | 4 | 4 | 70.29 | 1.9 × 10⁻³ |

These are empirical results from inventor's own implementations. ResNet50 is included as it can also be quantized using asymmetric quantization, although in their experiments the inventors only applied asymmetric quantization to SilU and GeLU based architectures. It is worth noting that according to LSQ+ (seeYash Bhalgat, Jinwon Lee, Markus Nagel, Tijmen Blankevoort, and Nojun Kwak, “Lsq+: Improving low-bit quantization through learnable offsets and better initialization”, CVPR Workshops, pp. 696-697, 2020, which is incorporated herein by reference) asymmetric quantization can be achieved at virtually no run-time cost.

### Improvement With Respect to QAT

It was explained above that data-driven quantization schemes performance define an upper bound on data-free performance. The present disclosure allows to narrow the resulting gap between these methods. In Table 10 below, it is reported the evolution in the gap between data-free and data-driven quantization techniques. These empirical results validate the significant improvement of the proposed method at narrowing the gap between data-free and data-driven quantization methods by 26.66% to 29.74%.

TABLE 10
Performance Gap as compared to Data-driven techniques on ResNet 50
quantization in W4/A4. The relative gap improvement to the state-of-the-art
$SQuant , is measured as \frac{gs - gp}{gs} gs with gs = \frac{* - SQuant}{*} and$
$gp = \frac{* - PowerQuant}{*}$

| data-driven method | SQuant | PowerQuant | relative gap |
|---|---|---|---|
| OCTAV [symbol] [symbol] (ICML) | 8.72% | 6.15% | +29.47% |
| SQ [symbol] [symbol] (CVPR) | 8.64% | 6.07% | +29.74% |
| WinogradQ [symbol] [symbol] (CVPR) | 9.55% | 7.00% | +26.66% |
| Mr BrQ [symbol] [symbol] (CVPK) | 8.74% | 6.17% | +29.38% |

where * is the performance of a data-driven method

In order to complete the comparison to QAT methods, it is considered the short-re-training (30 epochs) regime from OCTAV in Table 11 shown below. Two observations can be drawn from this comparison. First, on ResNet 50, OCTAV achieves remarkable results by reach near full-precision accuracy. Still the proposed method does not fall too far back with only 5.31 points lower accuracy while being data-free. Second, on very small models such as MobileNet V2, using a strong quantization operator rather than a short re-training leads to a huge accuracy improvement as PowerQuant achieves 45.18 points higher accuracy. This is also the finding of the author in OCTAV, as they conclude that models such as MobileNet tend to be very challenging to quantize using static quantization and short re-training.

TABLE 11
Performance gap between data-free PowerQuant and short-retraining
(see Charbel Sakr, Steve Dai, Rangha Venkatesan, Brian Zimmer,
William Dally, and Brucek Khailany. “Optimal clipping
and magnitude-aware differentiation for improved quantization-
aware training”, In ICML, pp. 19123-19138. PMLR, 2022.,
which is incorporated herein by reference)

| method | architecture | quantization | accuracy |
|---|---|---|---|
| PowerQuant | ResNet 50 | W4/A4 | 70.33 |
| OCTAV | ResNet 50 | W4/A4 | 75.84 |
| PowerQuant | MobileNet V2 | W4/A4 | 45.84 |
| OCTAV | MobileNet V2 | W4/A4 | 0.66 |

In Table 12 below, it is drawn a comparison between the proposed PowerQuant and the QAT method OCTAV previously discussed, both using dynamic quantization (i.e. estimating the ranges of the activations on-the-fly depending on the input). As expected, the use of dynamic ranges has a considerable influence on the performance of both quantization methods. As can be observed the QAT method OCTAV achieved very impressive results and even outperforming the full-precision model on ResNet 50. Nevertheless, it is on MobileNet that the influence of dynamic ranges is the most impressive. For OCTAV, it is observed a boost of almost 71 points going from almost random predictions to near exact full-precision accuracy. It is to be noted that PowerQuant does not fall shy in front of these performances, as using static quantization the inventors still manage to preserve some of the predictive capability of the model. Furthermore, using dynamic quantization, Powerquant achieves similar accuracies than OCTAV while not involving any fine-tuning, contrary to OCTAV.

TABLE 12
Performance gap between PowerQuant and OCTAV (using an additional
short retraining), both using dynamic range estimation.

| method | architecture | quantization | accuracy |
|---|---|---|---|
| PowerQuant | ResNet 50 | WA/A4 | 76.02 |
| OCTAV | ResNet 50 | W4/A4 | 76.46 |
| PowerQuant | MobileNet V2 | W4/A4 | 71.65 |
| OCTAV | MobileNet V2 | W4/A4 | 71.23 |

All in all, it can be concluded that the proposed data-free method manages to hold close results to a state-of-the-art QAT method in some context. An interesting future work may be the extension of PowerQuant as a QAT method and possibly learning the power parameter a that is used in the proposed quantization operator.

### Comparison to State-of-the-Art Data-Free Quantization on other ConvNets

In addition to the evaluation on ResNet, it is now propose some complementary results on DenseNet in Table 13 below as well as the challenging and compact architectures MobileNet and EfficientNet in Table 14 below as well as weights only for Bert in Table 16 below. In table 13, it is reported the performance of other data-free quantization processes on DenseNet 121. The OMSE method (see Yoni Choukroun, Eli Kravchik, Fan Yang, and Pavel Kisilev, “Low-bit quantization of neural networks for efficient inference”, ICCV Workshops, pp. 3009-3018, 2019, which is incorporated herein by reference) is a post-training quantization method that leverages validation examples during quantization, thus cannot be labelled as data-free. Yet, this work is included in the comparison as they show strong performance in terms of accuracy at a very low usage of real data. As showcased in table 13, the proposed PowerQuant method almost preserves the floating point accuracy in W8/A8 quantization. Additionally, on the challenging W4/A4 setup, the approach proposed herein improves the accuracy by a remarkable 12.30 points over OMSE and 17.54 points over SQuant. This is due to the overall better efficiency of non-uniform quantization, that allows a theoretically closer fit to the weight distributions of each DNN layer. The results on MobileNet and EfficientNet from Table 14 confirm the previous findings. It is observed a significant boost in performance from PowerQuant as compared to the other very competitive data-free solutions.

TABLE 13
Comparison between state-of-the-art post-training quantization
techniques on DenseNet 121 on ImageNet. It is distinguished
between methods relying on data (synthetic or real) or not.
In addition to being fully data-free. the proposed approach
significantly outperforms existing methods.

| Architecture | Method | Data | W-bit | A-bit | Accuracy | gap |
|---|---|---|---|---|---|---|
| DenseNet | Baseline | — | 32 | 32 | 75.00 | — |
| 121 | DFQ [symbol] ( [symbol] | No | 8 | 8 | 74.75 | −0.25 |
| | SQuant [symbol] ( [symbol] | No | 8 | 8 | 74.70 | −0.30 |
| | OMSE [symbol] | Real | 8 | 8 | 74.97 | −0.03 |
| | SPIQ [symbol] ( [symbol] | No | 8 | 8 | 75.00 | −0.00 |
| | PowerQuant | No | 8 | 8 | 75.00 | −0.00 |
| | DFQ [symbol] ( [symbol] | No | 4 | 4 | 0.10 | −74.90 |
| | SQuant [symbol] ( [symbol] | No | 4 | 4 | 47.14 | −27.86 |
| | SPIQ [symbol] ( [symbol] | No | 4 | 4 | 51.83 | −23.17 |
| | OMSE [symbol] | Real | 4 | 4 | 57.07 | −17.93 |
| | PowerQuant | No | 4 | 4 | 69.37 | −5.63 |

TABLE 14
Complementary Benchmarks on ImageNet

| | | | W- | A- | Accu- | |
|---|---|---|---|---|---|---|
| Architecture | Method | Data | bit | bit | racy | gap |
| MobileNet | Baseline | — | 32 | 32 | 71.80 | — |
| V2 | DFQ (ICCV 2019) | No | 8 | 8 | 70.92 | −0.88 |
| | SQuant (ICLR 2022) | No | 8 | 8 | 71.68 | −0.12 |
| | SPIQ (WACV 2023) | No | 8 | 8 | 71.79 | −0.01 |
| | PowerQuant | No | 8 | 8 | 71.81 | +0.01 |
| | DFQ (ICCV 2019) | No | 4 | 4 | 27.1 | −44.70 |
| | SQuant (ICLR 2022) | No | 4 | 4 | 28.21 | −43.59 |
| | SPIQ (WACV 2023) | No | 4 | 4 | 31.28 | −40.52 |
| | PowerQuant | No | 4 | 4 | 45.84 | −25.96 |
| EfficientNet | Baseline | — | 32 | 32 | 77.10 | — |
| B0 | DFQ (ICCV 2019) | No | 8 | 8 | 76.89 | −0.21 |
| | SQuant (ICLR 2022) | No | 8 | 8 | 76.93 | −0.17 |
| | SPIQ (WACV 2023) | No | 8 | 8 | 77.02 | −0.08 |
| | PowerQuant | No | 8 | 8 | 77.05 | −0.05 |
| | DFQ (ICCV 2019) | No | 6 | 6 | 43.08 | −34.02 |
| | SQuant (ICLR 2022) | No | 6 | 6 | 54.51 | −32.59 |
| | SPIQ (WACV 2023) | No | 6 | 6 | 74.67 | −2.43 |
| | PowerQuant | No | 6 | 6 | 75.13 | −1.97 |

TABLE 15
Complementary Benchmarks on Vision Transformers for ImageNet

| Archi- | | | W- | A- | | |
|---|---|---|---|---|---|---|
| tecture | Method | Data | bit | bit | Accuracy | gap |
| CaiT | Baseline | — | 32 | 32 | 78.524 | — |
| xxs24 | DFQ (ICCV 2019) | No | 8 | 8 | 77.612 | −0.912 |
| | SQuant (ICLR 2022) | No | 8 | 8 | 77.638 | −0.886 |
| | PowerQuant | No | 8 | 8 | 77.718 | −0.806 |
| | DFQ (ICCV 2019) | No | 4 | 8 | 74.192 | −4.332 |
| | SQuant (ICLR 2022) | No | 4 | 8 | 74.224 | −4.300 |
| | PowerQuant | No | 4 | 8 | 75.104 | −3.420 |
| CaiT | Baseline | — | 32 | 32 | 79.760 | — |
| xxs36 | DFQ (ICCV 2019) | No | 8 | 8 | 79.000 | −0.760 |
| | SQuant (ICLR 2022) | No | 8 | 8 | 78.914 | −0.846 |
| | PowerQuant | No | 8 | 8 | 79.150 | −0.610 |
| | DFQ (ICCV 2019) | No | 4 | 8 | 76.906 | −2.854 |
| | SQuant (ICLR 2022) | No | 4 | 8 | 76.896 | −2.864 |
| | PowerQuant | No | 4 | 8 | 77.702 | −2.058 |
| CaiT | Baseline | — | 32 | 32 | 83.368 | — |
| s24 | DFQ (ICCV 2019) | No | 8 | 8 | 82.802 | −0.566 |
| | SQuant (ICLR 2022) | No | 8 | 8 | 82.784 | −0.584 |
| | PowerQuant | No | 8 | 8 | 82.766 | −0.602 |
| | DFQ (ICCV 2019) | No | 4 | 8 | 81.474 | −1.894 |
| | SQuant (ICLR 2022) | No | 4 | 8 | 81.486 | −1.882 |
| | PowerQuant | No | 4 | 8 | 81.612 | −1.756 |

TABLE 16
Complementary Benchmarks on the GLUE task. It is considered the BERT
transformer architecture. It is provided the reference performance
of BERT on GLUE as well as the reproduced results (baseline).

| task | (reference) | baseline | uniform | log | power |
|---|---|---|---|---|---|
| CoLA | 49.23 | 47.90 | 46.24 | 46.98 | 47.77 |
| SST-2 | 91.97 | 92.32 | 91.28 | 91.85 | 92.32 |
| MRPC | 89.47/85.29 | 89.32/85.41 | 86.49/81.37 | 86.65/82.86 | 89.32/85.41 |
| STS-B | 83.95/83.70 | 84.01/83.87 | 83.25/83.14 | 84.01/83.81 | 84.01/83.87 |
| QQP | 88.40/84.31 | 90.77/84.65 | 90.23/84.61 | 90.76/84.65 | 90.77/84.65 |
| MNLI | 80.61/81.08 | 80.54/80.71 | 79.72/79.13 | 79.22/79.71 | 80.54/80.71 |
| QNLI | 87.46 | 91.47 | 90.32 | 91.43 | 91.47 |
| RTE | 61.73 | 61.82 | 59.23 | 61.27 | 61.68 |
| WNLI | 45.07 | 43.76 | 40.85 | 42.80 | 42.85 |

### Overhead Cost

It is now provided more empirical results on the inference cost of the proposed method. Table 17 below shows the inference time of DNNs quantized with the proposed approach (which only implies modifications of the activation function and a bias correction-see Section 3.3). For DenseNet, ResNet and MobileNet V2, the baseline activation function is the ReLU, which is particularly fast to compute.

TABLE 17
Inference time, in seconds, over ImageNet using batches
of size 16 of several networks on a 2070 RTX GPU. It is
also reported the accuracy for W6/A6 quantization setup.

| Architecture | Method | inference time (gap) | accuracy |
|---|---|---|---|
| ResNet 50 | Uniform | 164 | 75.07 |
| | Power Function | 164 (+0.2) | 75.95 |
| DenseNet 121 | Uniform | 162 | 72.71 |
| | Power Function | 167 (+4.8) | 74.84 |
| MobileNet V2 | Uniform | 85 | 52.20 |
| | Power Function | 86 (+0.7) | 64.09 |
| EfficientNet B0 | Uniform | 125 | 58.24 |
| | Power Function | 127 (+2.2) | 66.38 |

Nevertheless, the results show that the proposed approach leads to only increasing by 1% the whole inference time on most networks. More precisely, in the case of ResNet 50, the change in activation function induces a slowdown of 0.15%. The largest runtime increase is obtained on DenseNet with a 3.4% increase. Lastly, the approach is also particularly fast and efficient on EfficientNet BO, which uses SiLU activation, thanks to the bias correction technique introduced above. Overall, the proposed approach can be easily implemented and induces negligible overhead in inference on GPU. To furthermore justify the practicality of the proposed quantization process, it is to be reminded that the only practicality concern that may arise is on the activation function as the other operations are strictly identical to standard uniform quantization. According to prior art research, efficient power functions can be implemented for generic hardware as long as they support standard integer arithmetic, i.e. as long as they support uniform quantization. When it comes to Field-Programmable Gate Array (FPGA), activation functions are implemented using look-up tables (LUT) as detailed in Hajduk (2017). More precisely, they are pre-computed using Pade approximation which are quotients of polynomial functions. Consequently the proposed approach would simply change the polynomial values but not the inference time as it would still rely on the same number of LUTs.

In general, activation functions that are non-linear can be very effectively implemented in quantization runtime. However these considerations are hardware agnostic. In order to circumvent this limitation and best address any concerns, the inventors conducted a small study using the simulation tool nntool from GreenWaves, a risc-v chips manufacturer that enables to simulate inference cost of quantized neural networks on their gap unit. The inventors tested a single convolutional layer with bias and relu activation plus the power quantization operation and reported the number of cycles and operations. These results demonstrate that even without any optimization the proposed method has a marginal computational cost on MCU inference which corroborates the previous empirical results. It is to be noted that this cost could be further reduced via optimizing the computation of the power function using existing methods, for example as discussed in Sehoon Kim, Amir Gholami, Zhewei Yao, Michael W Mahoney, and Kurt Keutzer, “I-bert: Integeronly bert quantization”, In International conference on machine learning, pp. 5506-5518. PMLR, 2021, which is incorporated herein by reference. Similarly, the inventors measured the empirical time required to perform the proposed quantization method on several neural networks and the results are reported in table 19 below. These results show that the proposed PowerQuant method offers outstanding trade-offs in terms of compression and accuracy at virtually no cost over the processing and inference time as compared to other data-free quantization methods. For example, SQuant is a sophisticated method that requires heavy lifting in order to efficiently process a neural network. On a CPU, it requires at least 100 times more time to reach a lower accuracy than the proposed method.

TABLE 18
Inference cost each component of a convolutional layer and
percentage of total in terms of number of cycles on a wide
range of simulated hardware using nntool from GreenWaves.

| operation | number of cycles | number of ops | % of total cycles | % of total ops |
|---|---|---|---|---|
| convolution | 22950 | 442368 | 85.482% | 99.310% |
| bias | 2033 | 1024 | 7.573% | 0.229% |
| ream | 924 | 1024 | 3.442% | 0.229% |
| power function | 940 | 1024 | 3.502% | 0.229% |

TABLE 19
It is reported the processing time in seconds (on an Intel(R)
Core(TM) i9-9900K CPU) required to quantize a trained neural
network such as ResNet, MobileNet, DenseNet or EfficientNet.

| Architecture | GDPQ | SQuant | Uniform | Power |
|---|---|---|---|---|
| MobileNet V2 | 7.10³ | 134 | <1 | <1 |
| ResNet 50 | 11.10³ | 320 | <1 | 1.3 |

The quantization method and the matrix multiplication method are computer-implemented. This means that steps (or substantially all the steps) of the methods are executed by at least one computer, or any system alike. Thus, steps of the methods are performed by the computer, possibly fully automatically, or, semi-automatically. In examples, the triggering of at least some of the steps of the methods may be performed through user-computer interaction. The level of user-computer interaction required may depend on the level of automatism foreseen and put in balance with the need to implement user's wishes. In examples, this level may be user-defined and/or pre-defined.

A typical example of computer-implementation of a method is to perform the method with a system adapted for this purpose. The system may comprise a processor coupled to a memory and a graphical user interface (GUI), the memory having recorded thereon a computer program comprising instructions for performing the method. The memory may also store a database. The memory is any hardware adapted for such storage, possibly comprising several physical distinct parts (e.g. one for the program, and possibly one for the database).

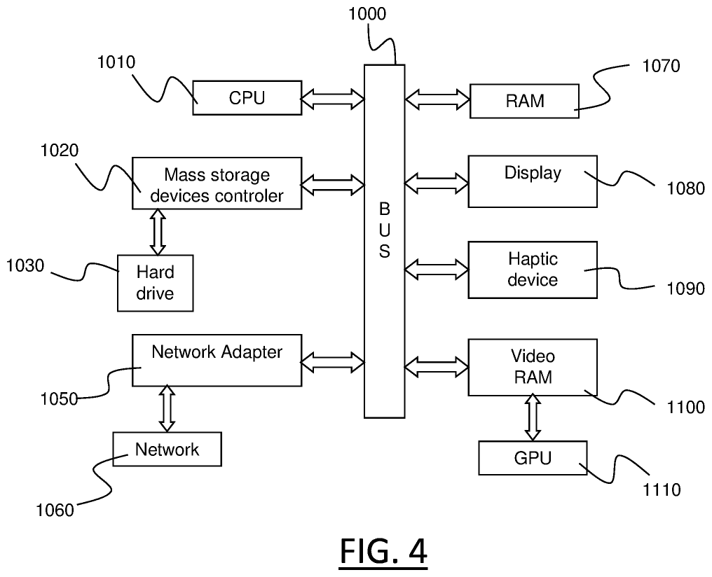

FIG. 4 shows an example of the system, wherein the system is a client computer system, e.g. a workstation of a user.

The client computer of the example comprises a central processing unit (CPU) 1010 connected to an internal communication BUS 1000, a random access memory (RAM) 1070 also connected to the BUS. The client computer is further provided with a graphical processing unit (GPU) 1110 which is associated with a video random access memory 1100 connected to the BUS. Video RAM 1100 is also known in the art as frame buffer. A mass storage device controller 1020 manages accesses to a mass memory device, such as hard drive 1030. Mass memory devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks. Any of the foregoing may be supplemented by, or incorporated in, specially designed ASICs (application-specific integrated circuits). A network adapter 1050 manages accesses to a network 1060. The client computer may also include a haptic device 1090 such as cursor control device, a keyboard or the like. A cursor control device is used in the client computer to permit the user to selectively position a cursor at any desired location on display 1080. In addition, the cursor control device allows the user to select various commands, and input control signals. The cursor control device includes a number of signal generation devices for input control signals to system. Typically, a cursor control device may be a mouse, the button of the mouse being used to generate the signals. Alternatively or additionally, the client computer system may comprise a sensitive pad, and/or a sensitive screen.

The computer program may comprise instructions executable by a computer, the instructions comprising means for causing the above system to perform the method. The program may be recordable on any data storage medium, including the memory of the system. The program may for example be implemented in digital electronic circuitry, or in computer hardware, firmware, software, or in combinations of them. The program may be implemented as an apparatus, for example a product tangibly embodied in a machine-readable storage device for execution by a programmable processor. Method steps may be performed by a programmable processor executing a program of instructions to perform functions of the method by operating on input data and generating output. The processor may thus be programmable and coupled to receive data and instructions from, and to transmit data and instructions to, a data storage system, at least one input device, and at least one output device. The application program may be implemented in a high-level procedural or object-oriented programming language, or in assembly or machine language if desired. In any case, the language may be a compiled or interpreted language. The program may be a full installation program or an update program. Application of the program on the system results in any case in instructions for performing the method. The computer program may alternatively be stored and executed on a server of a cloud computing environment, the server being in communication across a network with one or more clients. In such a case a processing unit executes the instructions comprised by the program, thereby causing the method to be performed on the cloud computing environment.

1. A computer-implemented method for neural network quantization, the method comprising:
obtaining:
a neural network, and
a quantization operator that is based on a power function having a power exponent; and
quantizing the neural network based on the quantization operator, the quantization including searching for an optimal value of the power exponent based on a quantization error associated with the quantization operator.

2. The method of claim 1, wherein searching for an optimal value of the power exponent includes:
minimizing the quantization error; or
determining a power exponent value compliant with the following criteria:
minimization of the quantization error; and
use a default power exponent, and/or minimization of a distance between the obtained neural network prior to quantization and the quantized neural network.

3. The method of claim 2, wherein the quantization operator is of the type:
$${Q}_{a} : W ↦ ⌊ ( {2}^{b - 1} - 1 ) \frac{sign ( W ) \times {\vert W \vert}^{a}}{max {\vert W \vert}^{a}} ⌋ ,$$
where a∈ [symbol] is the power exponent, b is the number of bits associated with the quantization operator, W represents a tensor, and all operations are performed element wise.

4. The method of claim 3, wherein the quantization error is of the type:
$$ϵ ( F , a ) = {\sum }_{l = 1}^{L} {‖ {W}_{l} - {Q}_{a}^{- 1} ( {Q}_{a} ( {W}_{l} ) ) ‖}_{p} ,$$
where ∥·∥ₚ denotes the L^{p} vector norm, {Wₗ, 1≤l≤L} represent the layers of the neural network, and Qₐ⁻¹ is the de-quantization operator and is of the type:
$${Q}_{a}^{- 1} ( W ) = sign ( W ) \times {\vert W \times \frac{max \vert W \vert}{{2}^{b - 1} - 1} \vert}^{\frac{1}{a}} .$$

5. The method of claim 4, wherein, for at least one layer with a signed activation function Act with input x and weights W, Qₐ⁻¹(Qₐ(x+C_{Act})Qₐ(W)) is approximated by xW+C_{Act}W, C_{Act}W being a bias term.

6. The method of claim 1, wherein the method comprises performing the quantization during a post-training calibration of the neural network.

7. The method of claim 6, wherein performing the quantization during a post-training calibration of the neural network uses a gradient descent.

8. The method of claim 1, wherein the method comprises performing the quantization by training the neural network, or by finetuning the neural network, the training comprising using power functions for quantization simulation.

9. The method of claim 1, wherein the quantization using the quantization operator concerns at least a part of the layers of the neural network.

10. The method of claim 1, wherein, during inference using the quantized neural networks, power of products are accumulated instead of accumulating the quantized products.

11. A computer-implemented method for performing multiplication of quantized matrices with a quantization operator that is based on a power function having a power exponent, the method comprising accumulating power of products.

12. A device comprising a non-transitory computer-readable data storage medium having recorded thereon:
a computer program comprising instructions for performing:
a method for neural network quantization, the method comprising:
obtaining:
a neural network, and
a quantization operator that is based on a power function having a power exponent;
quantizing the neural network based on the quantization operator, the quantization including searching for an optimal value of the power exponent based on a quantization error associated with the quantization operator, and/or
a method for performing multiplication of quantized matrices with a quantization operator that is based on a power function having a power exponent, the method comprising accumulating power of products, and/or
a quantized neural network obtainable according to the method for neural network quantization.

13. The device of claim 12, wherein searching for an optimal value of the power exponent includes:
minimizing the quantization error; or
determining a power exponent value compliant with the following criteria:
minimization of the quantization error; and
use a default power exponent, and/or minimization of a distance between the obtained neural network prior to quantization and the quantized neural network.

14. The device of claim 13, wherein the quantization operator is of the type:
$${Q}_{a} : ↦ ⌊ ( {2}^{b - 1} - 1 ) \frac{sign ( W ) \times {\vert W \vert}^{a}}{max {\vert W \vert}^{a}} ⌋ ,$$
where a∈ [symbol] is the power exponent, W represents a tensor, and all operations are performed element wise.

15. The device of claim 14, wherein the quantization error is of the type:
$$ϵ ( F , a ) = {\sum }_{l = 1}^{L} {‖ {W}_{l} - {Q}_{a}^{- 1} ( {Q}_{a} ( {W}_{l} ) ) ‖}_{p} ,$$
where ∥·∥ₚ denotes the L^{p} vector norm, {Wₗ, 1≤l≤L} represent the layers of the neural network, and Qₐ⁻¹ is the de-quantization operator and is of the type:
$${Q}_{a}^{- 1} ( W ) = sign ( W ) \times {\vert W \times \frac{max \vert W \vert}{{2}^{b - 1} - 1} \vert}^{\frac{1}{a}} .$$

16. The device of claim 15, wherein, for at least one layer with a signed activation function Act with input x and weights W, Qₐ⁻¹(Qₐ(x+C_{Act})Qₐ(W)) is approximated by xW+C_{Act}W, C_{Act}W being a bias term.

17. The device of claim 12, further comprising a processor coupled to the data storage medium.

18. The device of claim 13, further comprising a processor coupled to the data storage medium.

19. The device of claim 14, further comprising a processor coupled to the data storage medium.

20. The device of claim 15, further comprising a processor coupled to the data storage medium.
